(19) United States
(12) Patent Application Publication
(10) Pub. No.: US 2011/0254409 A1
(43) Pub. Date: Oct. 20, 2011

(54) Reduced size and light weight hub dynamo of bicycle

(76) Inventor: Yng-Long Lee, Taipei City (TW)

(21) Appl. No.: 12/761,650

(22) Filed: Apr. 16, 2010

(51) Int. Cl. B62J 6/12

(52) U.S. Cl. 310/67 A

(57) ABSTRACT

A reduced size and light weight hub dynamo of bicycle is capable of increasing the power output when the bicycle runs at a relatively low speed. The hub dynamo of bicycle comprises a hub, at least two magnetic rotor sleeves, magnet isolation sleeves disposed among the magnetic sleeves, at least two coil stators, parting members disposed between the coil stators, a central shaft, two bearings and a locking assembly. Such arrangements increase the number of the power generating units consisting of magnetic rotor sleeve and coil stator. The N-S poles of neighboring magnetic rotor sleeves have a phase difference with respect to one another, or the teeth of the claw poles of the neighboring coil stator having a phase difference with respect to one another.

### BACKGROUND OF THE INVENTION

1. Field of the Invention

The present invention relates to a hub dynamo, and more particularly to a reduced size and light weight hub dynamo of bicycle which is capable of increasing the power output when the bicycle runs at a relatively low speed.

2. Description of the Prior Art

A conventional hub dynamo of bicycle normally comprises a power generating unit consisting of a hub body, a magnetic rotator sleeve and a coil stator, a shaft, a cover, a bearing and fasteners.

The power generating unit is disposed in the hub body. The coil stator, consisting of coils and an iron core, is disposed in a fitting space of the magnetic rotator sleeve, and around the periphery of the coils are disposed a plurality of alternatively arranged toothed polar pieces. The magnetic rotator sleeve includes a plurality of permanent magnets with N/S poles alternatively arranged and is mounted against the inner periphery of the hub. The power generating unit is mounted on the shaft of the hub. Both ends of the shaft extend out of the hub and are mounted onto the bearing brackets at both ends of the hub.

When the rider rides the bike, the magnetic rotator sleeve is rotated relative to the coil stator by the hub to produce current based on Faraday's Law, and then the current is outputted by the positive and negative wires connected to the coils. Since the magnets are disposed in the hub inner periphery and used as rotator, and the coils of the stator are mounted on the shaft of the bicycle, the magnetic rotator will rotate along the rotation of the wheels of the bicycle, namely, the rotation speed of the magnetic rotator sleeve is the same as that of the wheels of the bicycle. In order to improve the change rate of the magnetic field, the number of the poles of the magnets in the hub must be maintained at a certain level to prevent the voltage from dropping too low when the bicycle rotates slowly. Generally, the number of magnets of the existing hub dynamos ranges from 28 to 36, and the inner diameter of the hub must be large enough in order to hold all the magnets. Otherwise, the number of the magnet poles must be reduced, resulting in a low voltage output during low rotation speed of the bicycle.

TW Publication No M348702 discloses a multiple phase hub dynamo of bicycle which has at least two power generating units disposed in the hub, the two power generating units consist of two stators, polar toothed pieces being arranged at a phase difference, and a rotator mounted on the central shaft, so as to produce higher voltage or current for more electric appliances or large power electric appliance. However, the size of the hub is still large, and the rotator made of annularly arranged magnets is likely to cause magnetic interference with the stators.

Another conventional hub dynamo of bicycle is disclosed in TW Publication No M332625 and comprises a hub shaft, a hub, a first and second bearings and power generating units. The hub shaft is mounted on the front forks, the hub is disposed on the outer periphery of the hub shaft, and the bearings are disposed between the hub and the hub shaft for enabling the hub to rotate with respect to the hub shaft. The power units consisting of magnetic sleeves, coils and iron cores are mounted on the hub shaft in such a manner that the coils and iron cores are received in a spaced defined between two sleeves, around the periphery of the sleeves are a plurality of hooks which are annularly arranged and engaged in an alternating fashion with each other. In the hub are disposed more than two sets of magnetic sleeves, coils and iron cores, the magnetic sleeves are staggered in terms of electric angle. Between each coil and iron core is disposed a parting board, the coil and the iron core are disposed between two sleeves to form a claw pole which is arranged in a staggered manner with respect to a neighboring claw pole formed by another coil and iron core. When the wheel of the bicycle rotates, it drives the hub to rotate to produce electromagnetic current, reducing cogging torque while improving rotation efficiency. However, such design only improves the power generating units, but cannot reduce the size of the hub.

The present invention has arisen to mitigate and/or obviate the afore-described disadvantages.

### SUMMARY OF THE INVENTION

The primary object of the present invention is to provide a reduced size and light weight hub dynamo of bicycle which is capable of increasing the power output when the bicycle runs at a relatively low speed. The hub dynamo comprises a hub body, at least two magnetic rotor sleeves, magnet isolation sleeves disposed among the magnetic sleeves, at least two coil stators, parting members disposed between the coil stators, a central shaft, two bearings and a locking assembly. Such arrangements increase the number of the power generating units consisting of magnetic rotor sleeve and coil stator. The N/S poles of neighboring magnetic rotor sleeves have a phase difference with respect to one another, or the corresponding teeth of the claw poles of the neighboring coil stator having a phase difference with respect to one another.

### BRIEF DESCRIPTION OF THE DRAWINGS

FIG. 1 is an assembly view of a bicycle hub dynamo in accordance with a first embodiment of the present invention;

FIG. 2 is an exploded view of the bicycle hub dynamo in accordance with the first embodiment of the present invention;

FIG. 3 is a partial exploded view of the bicycle hub dynamo in accordance with the first embodiment of the present invention;

FIG. 4 is a cross sectional view of the bicycle hub dynamo in accordance with the first embodiment of the present invention;

FIG. 5 is an exploded view of a bicycle hub dynamo in accordance with a second embodiment of the present invention; and

FIG. 6 is a partial exploded view of the bicycle hub dynamo in accordance with the second embodiment of the present invention.

### DETAILED DESCRIPTION OF THE PREFERRED EMBODIMENTS

The present invention will be clearer from the following description when viewed together with the accompanying drawings, which show, for purpose of illustrations only, the preferred embodiment in accordance with the present invention.

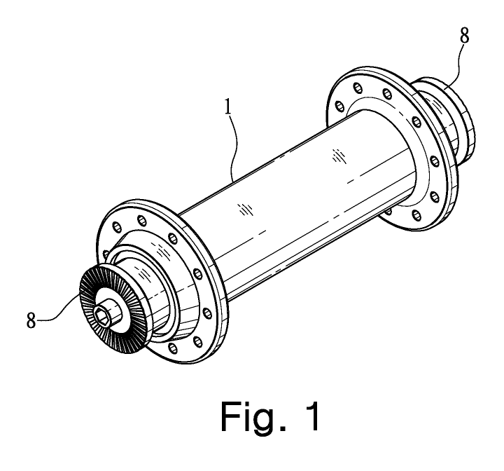

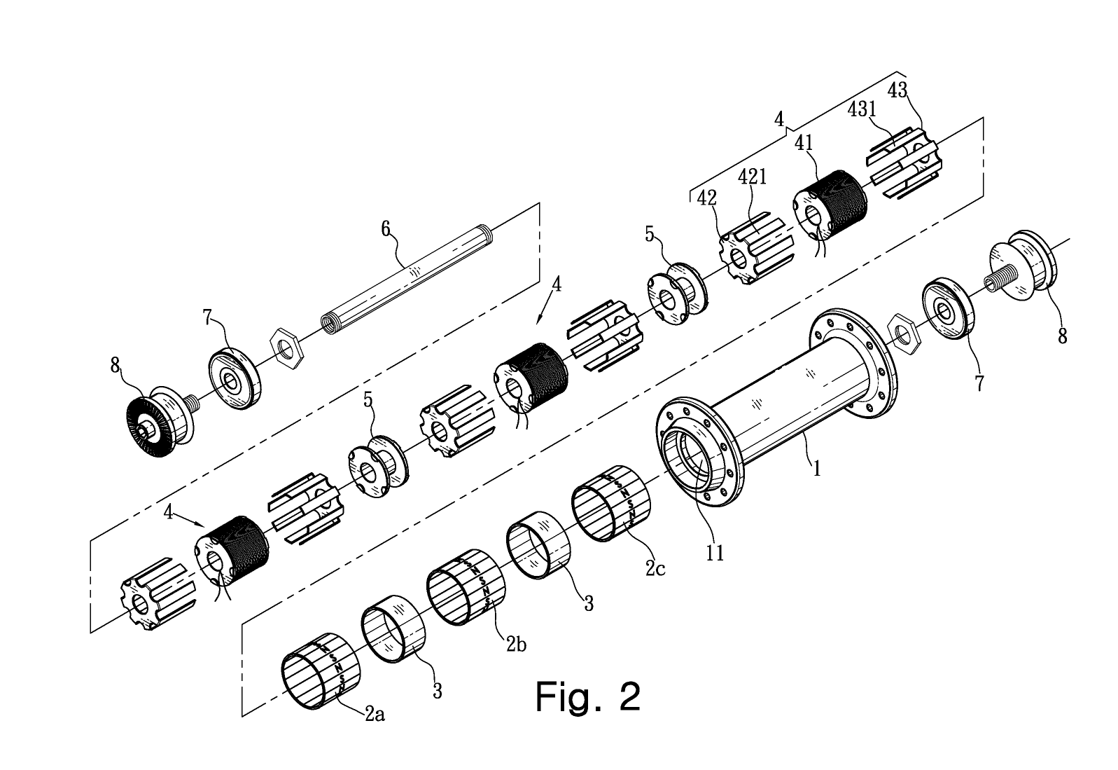

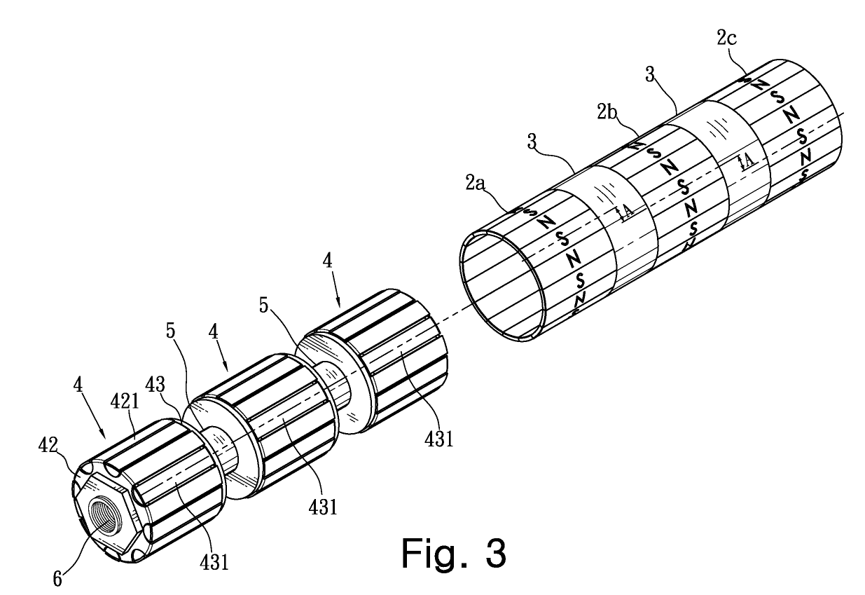

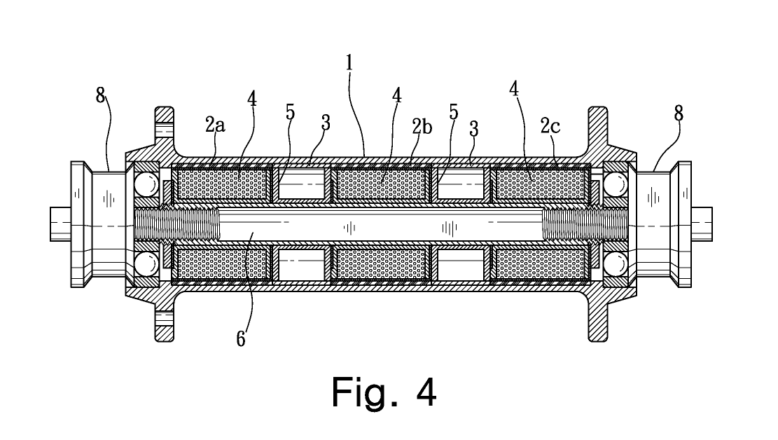

Referring to FIGS. 1-4, a reduced size and light weight hub dynamo of bicycle in accordance with the present invention comprises a hub body 1, at least two magnetic rotor sleeves 2a, 2b and 2c, magnet isolation sleeves 3 disposed among the magnetic sleeves, at least two coil stators 4, parting members 5 disposed between the coil stators 4, a central shaft 6, two bearings 7 and a locking assembly 8.

The hub body 1 is formed with a chamber 11.

The magnetic rotor sleeves 2a, 2b and 2c are positioned against the inner periphery of the chamber 11 of the hub body 1 and each consist of a plurality of alternating N/S poles. The N/S poles of the neighboring magnetic rotor sleeves are arranged a phase difference A with respect to one another. (which have a phase difference A with respect to one another

[symbol]

[symbol]

The magnet isolation sleeves 3 are disposed among the magnetic rotor sleeves 2a, 2b and 2c to reduce the magnet interference there between.

The coil stators 4 each include a coil 41 and two claw poles 42, 43. The claw poles 42, 43 are each provided with a plurality of teeth 421, 431 and mounted outside the coil 41 in such a manner that the teeth 421, 431 are engaged with each other in an alternating fashion, and the number of the teeth 421, 431 corresponds to that of the poles of the magnetic rotor sleeves 2a, 2b and 2c. The teeth 421, 431 of the claw poles 42, 43 of the neighboring coil stator 4 have no phase difference with respect to one another.

The parting members 5 are disposed between the coil stators 4 and located corresponding to the magnet isolation sleeves 3 to separate the coil stators 4 from each other.

The bearings 7 are mounted at both ends of the chamber 11.

The locking assembly 8 is employed to lock the central shaft 6 in the hub 1, in this embodiment, the locking assembly 8 includes two bolts inserted through the bearings 7 and fastened at both ends of the central shaft 6.

Since the magnetic rotor sleeves 2a, 2b and 2c around the inner periphery of the chamber 11 cooperate with the coil stators 4 to form a plurality of power generating units which are separated from one another by the magnet isolation sleeves 3 and the parting members 5, each power generating unit can generate power independently without interfering with each other. Furthermore, the alternating N/S poles of neighboring magnetic rotor sleeves 2a, 2b and 2c have a phase difference A with respect to one another. When a rider rides the bicycle, the wheel will drive the hub to rotate, causing the rotation of the magnetic rotor sleeves 2a, 2b and 2c with a phase difference A with respect to one another. The teeth 421, 431 of the claw poles 42, 43 of the first one of the power generating units 4 disposed in the chamber 11 receive the lines of N-pole and S-pole magnetic forces generated from the first magnetic rotor sleeve 2a, respectively. After a phase difference A, the teeth 421, 431 of the claw poles 42, 43 of the second power generating unit 4 disposed in the chamber 11 receive the lines of N-pole and S-pole magnetic forces generated from the second magnetic rotor sleeve 2b, respectively, and then after a phase difference A, the teeth 421, 431 of the claw poles 42, 43 of the third power generating unit 4 disposed in the chamber 11 receive the lines of N-pole and S-pole magnetic forces generated from the third magnetic rotor sleeve 2c, respectively. Therefore, within the induction period (360 degrees/14=25.71 degrees for 28 N-S magnetic poles sleeves) of each of the power generating units, the number of times that the magnetic rotor sleeves 2a, 2b, and 2c are aligned with the poles of the coil stators 4 is increased, which consequently resulting in an increase in number of times of magnetic force lines cut, enabling the coils to produce more current while increasing the electric power output.

Hence, with the design of having a phase difference A with respect to one another for the three magnetic rotor sleeves 2a, 2b and 2c, the number of magnetic poles of the magnetic rotor sleeves and the corresponding number of the teeth 421, 431 of the claw poles 42, 43 of the coil stators 4 can be reduced. For example, the number of N-S poles can reduce from 28 to 14, while the number of the power generating unit increased from 1 to 3, and as a result, the power output increases 1.5 times ({14/28}×{3/1}=1.5). Therefore, the diameter of the hub, the size of the coil stators 4 and the weight of the hub of the present invention can be reduced; meanwhile, the current output is increased to provide enough electric power even if the bicycle runs slowly.

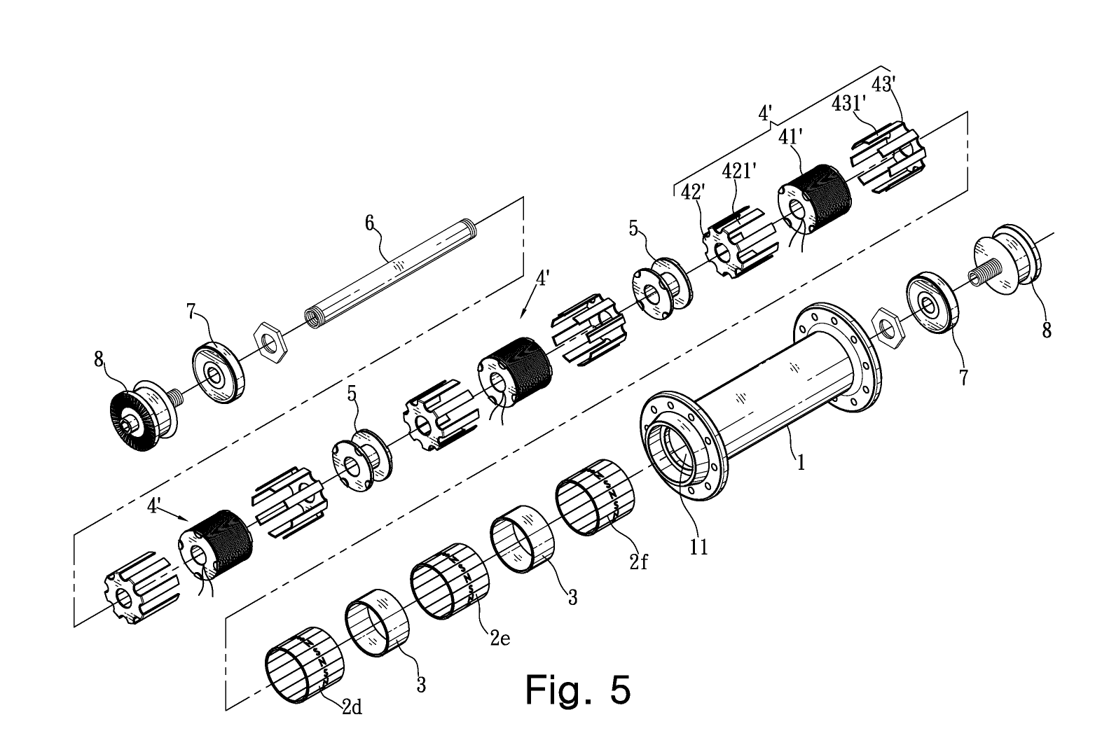

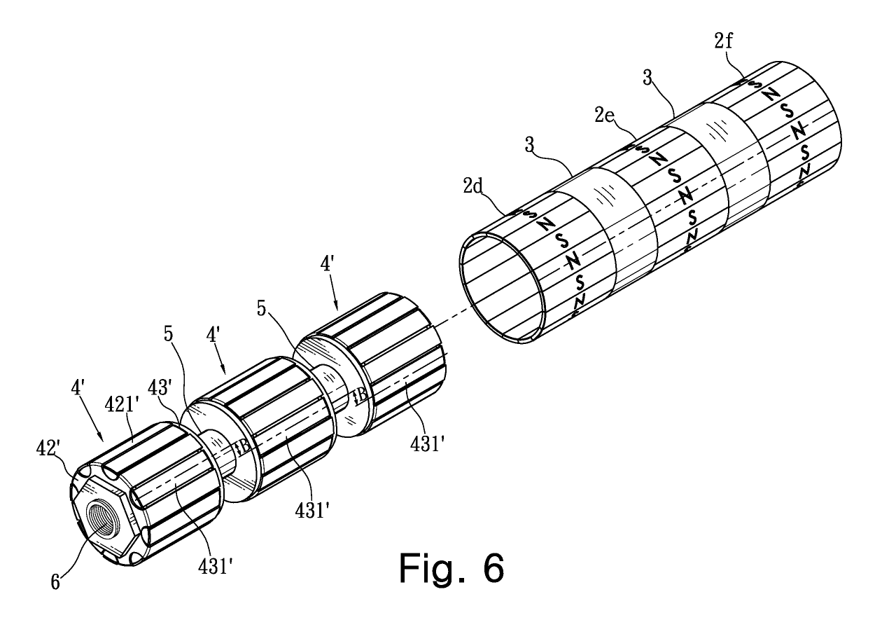

Referring to FIGS. 5 and 6, another embodiment of the present invention is shown and similar to the previous embodiment, except that: the magnetic rotor sleeves 2d, 2e and 2f do not have phase difference with respect to one another. The hub dynamo of this embodiment also comprises a hub body 1, at least two magnetic rotor sleeves 2d, 2e and 2f, magnet isolation sleeves 3 disposed among the magnetic sleeves, at least two coil stators 4′, parting members 5 disposed between the coil stators 4′, a central shaft 6, two bearings 7 and a locking assembly 8.

The hub 1 is formed with a chamber 11.

The magnetic rotor sleeves 2d, 2e and 2f are positioned against the inner periphery of the chamber 11 of the hub 1 and each consist of a plurality of alternating N-S poles and the north or south poles of each rotor sleeves are aligned with no phase difference with respect to one another.

The magnet isolation sleeves 3 are disposed among the magnetic rotor sleeves 2d, 2e and 2f to reduce the magnet interference there between.

The coil stators 4′ each include a coil 41′ and two claw poles 42′, 43′. The claw poles 42′, 43′ are each provided with a plurality of teeth 421′, 431′ and mounted outside the coil 41′ in such a manner that the teeth 421′, 431′ are engaged with each other, and the number of the teeth 421′, 431′ corresponds to that of the poles of the magnetic rotor sleeves 2d, 2e and 2f. The teeth 421′, 431′ of the claw poles 42′, 43′ of the neighboring coil stator 4′ have a phase difference B with respect to one another.

The parting members 5 are disposed between the coil stators 4′ and located corresponding to the magnet isolation sleeves 3 to separate the coil stators 4′ from each other.

The bearings 7 are mounted at both ends of the chamber 11.

The locking assembly 8 is employed to lock the central shaft 6 in the hub 1, in this embodiment, the locking assembly 8 includes two bolts inserted through the bearings 7 and fastened at both ends of the central shaft 6.

With the design of the teeth 421′, 431′ of the claw poles 42′, 43′ of the neighboring coil stator 4′ have a phase difference B with respect to one another and the N/S poles of the three magnetic rotor sleeves 2d, 2e and 2f have no phase difference aligned with one another respectively, the arrangement can provide more electric power even when the bicycle runs slowly, and thus the hub dynamo can be designed to have light weight and small size.

While we have shown and described various embodiments in accordance with the present invention, it is clear to those skilled in the art that further embodiments may be made without departing from the scope of the present invention.

What is claimed is:

1. A reduced size and light weight hub dynamo of bicycle comprises:
a hub formed with a chamber;
at least two magnetic rotor sleeves positioned against an inner periphery of the chamber of the hub and each consisting of a plurality of alternating N/S poles, the N/S poles of the neighboring magnetic rotor sleeves being arranged a phase difference with respect to one another;
at least one magnet isolation sleeves disposed between the magnetic rotor sleeves;
at least two coil stators mounted on a central shaft of the hub and located corresponding to the magnetic rotor sleeves, each coil stator including a coil and two claw poles, the claw poles being each provided with a plurality of teeth and mounted outside the coil in such a manner that the teeth are engaged with each other, and the number of the teeth corresponds to that of the poles of the magnetic rotor sleeves, the teeth of the claw poles of the neighboring coil stator having no phase difference with respect to one another;
at least one parting members disposed between the coil stators and located corresponding to the magnet isolation sleeves;
a bearings mounted at both ends of the chamber; and
a locking assembly employed to lock the central shaft in the hub.

2. The reduced size and light weight hub dynamo of bicycle as claimed in claim 1, wherein the numbers of the N/S poles of the magnetic rotator sleeves and the numbers of the teeth of the claw poles do not exceed 20.

3. The reduced size and light weight hub dynamo of bicycle as claimed in claim 1, wherein the locking assembly includes two bolts.

4. A reduced size and light weight hub dynamo of bicycle comprises:
a hub formed with a chamber;
at least two magnetic rotor sleeves positioned against an inner periphery of the chamber of the hub and each consisting of a plurality of alternating N/S poles, and the N/S poles of the neighboring magnetic rotor sleeves having no phase difference aligned with one another;
at least one magnet isolation sleeves disposed between the magnetic rotor sleeves;
at least two coil stators mounted on a central shaft of the hub and located corresponding to the magnetic rotor sleeves, each coil stator including a coil and two claw poles, the claw poles being each provided with a plurality of teeth and mounted outside the coil in such a manner that the teeth are engaged with each other, and the numbers of the teeth corresponds to that of the poles of the magnetic rotor sleeves, the teeth of the corresponding claw poles of the neighboring coil stator being arranged a phase difference with respect to one another;
at least one parting members disposed between the coil stators and located corresponding to the magnet isolation sleeves;
a bearings mounted at both ends of the chamber; and
a locking assembly employed to lock the central shaft in the hub.

5. The reduced size and light weight hub dynamo of bicycle as claimed in claim 4, wherein the numbers of the N/S poles of the magnetic rotator sleeves and the numbers of the teeth of the claw poles do not exceed 20.

6. The reduced size and light weight hub dynamo of bicycle as claimed in claim 4, wherein the locking assembly includes two bolts.
